(19) United States
(12) Patent Application Publication
(10) Pub. No.: US 2011/0281686 A1
(43) Pub. Date: Nov. 17, 2011

(54) Land vechicle braking system

(76) Inventor: Herman Desbrunes, Pompano Beach, FL (US)

(21) Appl. No.: 13/068,567

(22) Filed: May 16, 2011

Related U.S. Application Data
(63) Continuation of application No. 12/081,509, filed on Apr. 17, 2008, now abandoned.

(51) Int. Cl. B60W 30/08; B60W 10/18; G06F 19/00; B60W 10/04

(52) U.S. Cl. 477/185

(57) ABSTRACT

A braking system in a land vehicle having wheels for movement and a motor rotating the wheels. The braking system includes a brake rotor that is secured to one of the wheels. A brake caliper is secured to the vehicle for grasping the rotor in response to a caliper actuation signal. A brake pedal is secured to the land vehicle for movement by the vehicle driver. A pedal sensor is connected to the pedal for sensing the movement thereof and generating a braking signal in response to the movement of the pedal. A power train control module is secured to the vehicle for controlling the speed at which the motor rotates the wheels in response to a deactivation signal. A camera is mounting on the vehicle for generating a video signal representative of the incident light entering the camera. A central processing unit (CPU) is connected to the pedal sensor, the brake caliper and the camera. The CPU is adapted to receive the braking signal from the pedal sensor and, in response thereto, transmit a caliper actuation signal to the brake caliper. The CPU is also adapted to receive the video signal from the camera and process the video signal to determine whether the incident light entering camera includes light of a red color. In response to detecting light of a red color, CPU transmits a caliper actuation signal to the brake caliper and a deactivation signal to the power train control module.

This application is a continuation of U.S. patent application Ser. No. 12/081,509, filed on Apr. 17, 2008, now abandoned.

### FIELD OF THE INVENTION

The present invention relates generally to electrical communication apparatus and, more particularly, to land vehicle alarms and indicators of collision or contact with external objects.

### BACKGROUND OF THE INVENTION

Preventing collisions at roadway intersections has long been a goal of civil engineers working in the field. Numerous design features are commonly incorporated into intersections to minimize the likelihood of collisions. Typical of these features are: well-lit signals, bold signs and roadway markings, reduced speed zones, flat and straight roadway grades, and textured roadway surfaces for enhancing traction. These features all lengthen the effective stopping distance available to a vehicle at an intersection thereby increasing margins of safety.

Driver misbehavior has reduced the effectiveness of safe roadway designs. Inattentiveness, speeding, racing, and drinking have caused drivers cruise past stop signs and red light without noticing them. Furthermore, larger and heavier vehicles like SUVs and pickup trucks, favored by many drivers today, travel farther while stopping than typical automobiles at the time that many intersections were designed. Finally, an increasing use of private vehicles has led to unprecedented congestion and roadway crowding. Today, there are more opportunities than ever for vehicles to collide with one another at intersections and elsewhere on the roadways.

### SUMMARY OF THE INVENTION

In light of the problems associated with safely controlling the passage of land vehicles through roadway intersections, it is a principal object of the invention to provide a braking system that will automatically stop a land vehicle at a roadway intersection where a stop sign or red light is present. If a driver is inattentive or his vehicle is somehow out-of-control, his vehicle cannot run a stop sign or red light.

It is another object of the invention to provide a braking system of the type described that will automatically stop a land vehicle when following a vehicle with illuminated brake lights or when approaching a school bus with flashing warning lights. Thus, a driver of a vehicle employing the system cannot inadvertently rear-end another vehicle or pass a school bus that is loading or discharging passengers.

It is an object of the invention to provide improved features and arrangements thereof in a land vehicle braking system for the purposes described that is robust in construction, inexpensive to manufacture, and dependable in use.

The foregoing and other objects, features, and advantages of the present invention will become readily apparent upon further review of the following detailed description of the preferred embodiment as illustrated in the accompanying drawings.

### BRIEF DESCRIPTION OF THE DRAWINGS

The present invention may be more readily described with reference to the accompanying drawings, in which:

FIG. 1 is a schematic diagram of the components of my land vehicle braking system.

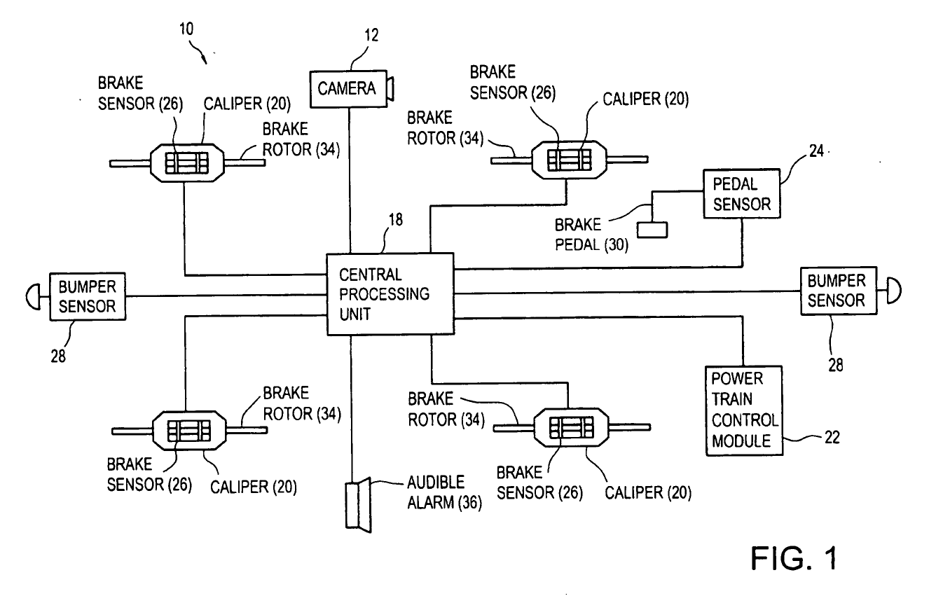

FIG. 2 is a schematic diagram of a roadway intersection wherein a land vehicle employing my braking system is approaching a stop sign.

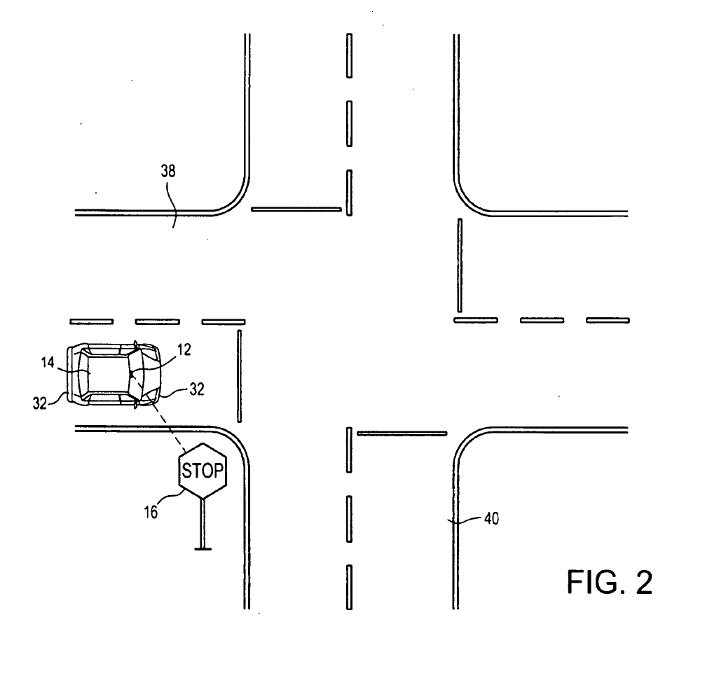

Similar reference characters denote corresponding features consistently throughout the accompanying drawings.

### DETAILED DESCRIPTION OF THE PREFERRED EMBODIMENT

Referring now to the FIGS., a land vehicle braking system in accordance with the present invention is shown at 10. System 10 includes a video camera 12 that is mounted on a land vehicle 14 for detecting sources of red light like traffic lights and stop signs as at 16 within its field of view. Camera 12 is connected to a central processing unit (CPU) 18 that serves as a controller of a number of brake calipers 20 and a power train control module 22 of vehicle 14. A number of sensors 24, 26 and 28 being connected respectively to the brake pedal 30, brake calipers 20, and bumpers 32 of vehicle 14 transmit data signals to CPU 18 that are considered by CPU 18 in controlling calipers 20 and power train control module 22.

Vehicle 14 is normally stopped by the application of downward pressure to brake pedal 30. Pedal 30 is located at the front of vehicle 14 where it can be easily pressed by one foot of the vehicle driver. A pedal sensor 24 connected to pedal 30 detects the amount of downward movement of pedal 30 caused by the driver. Sensor 24 produces a braking signal that is proportional to the amount of movement of pedal 30 and transmits the braking signal to CPU 18. In response to the braking signal received from pedal sensor 24, CPU 18 transmits a proportional, caliper actuation signal to each of brake calipers 20. Upon receiving the actuation signal, calipers 20 grasp brake rotors 34 with a pressure that is proportional to the downward travel of pedal 30.

It should be understood that the full downward movement of pedal 30 causes calipers 20 to apply the maximum gripping force to brake rotors 34 so as to stop moving vehicle 14 in the shortest distance. Less movement of pedal 30, however, results in: less severe deceleration, less strain upon the occupants of vehicle 14, and longer stopping distances. When the driver lifts his foot from pedal 30, a spring (not shown) returns pedal 30 to its original position thereby causing, by the generation and transmission of proportional braking and actuation signals, calipers 20 to fully release rotors 34 for unimpeded rotational movement of the vehicle wheels to which such are secured.

As vehicle 14 is being driven, camera 12 is activated to supplement the ability of the driver to stop vehicle 14 under adverse circumstances. Camera 12 includes a lens and an imager (neither shown) mounted together on the rearview mirror of vehicle 14. The lens gathers and focuses light from the area generally in front of vehicle 14 onto the imager. The imager, in turn, converts the incident light into an electronic video signal that is delivered to CPU 18 for processing.

For the sake of simplicity of operation of camera 12, the amount of light passing through the lens, the field of view of the lens, and the shutter speed of the lens are fixed at the time of manufacture. Alternatively, these optical characteristics can be automatically controlled by the addition of electronic controllers to camera 12. Providing controllers to camera 12 to enhance image quality is, of course, a matter of design choice and would add to the cost of system 10.

The imager is the “eye” of camera 12, housing a photosensor and a processor. The lens projects an image onto the photosensor for a predetermined period. The light exposure is converted into an electrical charge which is registered at the imager's output terminals. Then, the photosensor is reset to start the exposure-process for the next video frame. The processor receives and analog video signal from the photosensor and converts the imager output into a discrete digital video signal.

CPU 18 receives the video signal from the imager. A mathematical algorithm stored within CPU 18 is utilized to determine whether the video signal shows the presence of the color red indicating that vehicle 14 may be approaching: a stop light, a stop light, or a vehicle brake indicator light. If the color red within a predetermined frequency range is detected, the algorithm further determines the intensity of the color in order to estimate the distance of vehicle 14 to the color source.

The algorithm used by CPU 18 correctly assumes that stop signs 16 are uniform in terms of their: size, shape, color, reflectivity, and height positioned above the ground. Thus, the frequencies of light reflected by stop signs 16, when exposed to sunshine or vehicle headlights at night, can be reliably found to fall within a measurable range. These light frequencies corresponding to the color red, if present, are found in the video signals when they are analyzed by the algorithm. Traffic lights and the tail lights of land vehicles produce red light having wavelengths similar to that emitted by stop signs 16 that can be detected by camera 12 and processed within CPU 18 to yield information about their distance from vehicle 14.

The intensity of the red light received by camera 12 varies in proportion to the square of the distance that vehicle 14 has from stop sign 16. So, as the distance between vehicle 14 and stop sign 16 is halved, the intensity of the red light detected in CPU 18 by the algorithm is increased by a factor of four. The algorithm considers the incremental variations of light intensity for detected red light in determining whether, and how fast, vehicle 14 is approaching stop sign 16.

Environmental conditions can diminish the intensity of the light reaching camera 12. For example, dense cloudcover, fog, and falling precipitation can limit the amount of light passing from stop sign 16 to camera 12. Regardless, as red light intensity increases, the algorithm instructs CPU 18 that vehicle 14 is in the presence of, and is approaching, stop sign 16.

When vehicle 14 approaches stop sign 16 at speeds that are predetermined by algorithm to be too fast, algorithm causes CPU 18 to transmit an actuation signal to brake calipers 20 so as to grip rotors 34. This particular actuation signal is sufficient to reduce the forward speed of vehicle 14 to one wherein vehicle 14 is safely stopped prior to reaching stop sign 16. While vehicle 14 is being brought to a stop, camera 12 continuously provides CPU 18 with the video signal that is analyzed by the algorithm to determine whether deceleration is occurring at a sufficient rate. If not, CPU 18 makes an immediate adjustment to the actuation signal so as to stop vehicle 14 in a safe and timely manner.

To ensure that calipers 20 and rotors 34 are not prematurely worn out, CPU 18 transmits to power train control module 22 a motor deactivation signal simultaneous with the transmission of the caliper actuation signal. Power train control module 22, upon receiving the deactivation signal, immediately causes the vehicle motor to reduce power to an idling state where the motor is no longer driving vehicle 14 forward. Once vehicle 14 stops, or is overridden by the driver depressing brake pedal 30, the deactivation signal is terminated and power train control module 22 is thereby permitted to control the operation of the vehicle motor in a normal manner via driver inputs.

The driver of vehicle 14 is alerted prior to automatic braking of vehicle 14 by system 10. When practicable, a few seconds prior to CPU 18 automatically sending an actuation signal to brake calipers 20 and a deactivation signal to power train control module 22, CPU 18 transmits an alarm signal to audible alarm 36 positioned within the passenger compartment of vehicle 14 near camera 12. CPU 18 terminates the alarm signal after a predetermined period of time or when vehicle 14 is stopped.

Upon hearing the sound generated by alarm 36 and sensing impending danger, the driver of vehicle 14 may choose to press his foot against pedal 30. Downward movement of pedal 30 causes a braking signal to be transmitted from pedal sensor 24 to CPU 18. Under these circumstances, the braking control of vehicle 14 will remain with the driver since CPU 18 will not transmit caliper actuation and motor deactivation signals. Failure of the driver to depress brake pedal 30 and generate a braking signal will serve as an indication to CPU 18 to energize brake calipers 20 and deenergize the vehicle motor via power train control module 22.

Brake sensors 26 are associated with brake calipers 20 to provide feedback to CPU 18 regarding the operation of calipers 20. A brake sensor 26 is connected to each of calipers 20 to monitor the temperature of the wearing parts of the caliper 20, namely its brake pads (not shown). Each brake sensor 26 continuously transmits to CPU 18 a temperature signal while vehicle 14 is running.

CPU 18 produces caliper actuation signals, when necessary, that are proportional to the temperature signals received from brake sensors 26 as well as to movements of pedal 30 detected by pedal sensor 24. In the event that the temperatures detected by a brake sensors 26 are relatively hot, CPU 18 will cause any caliper actuation signals delivered therefrom to cause calipers 20 to grip rotors 34 with a relatively weak force to achieve adequate deceleration of vehicle 14. Conversely, when sensors 26 detect that calipers 20 are cold and not as able to provide as much grip when hot, CPU 18 will cause caliper actuation signals delivered therefrom to cause calipers 20 to grip rotors 34 with a relatively high force.

Bumper sensors 28 are mounted on the front and back of vehicle 14 and are operatively connected to CPU 18. Bumper sensors 28 detect significant impacts with objects outside vehicle 14 and transmit to CPU 18 contact signals when impacts occur. In response to receiving a contact signal, CPU 18 immediately transmits a caliper actuation signal to each of calipers 20 to grip rotors 34 with its full strength. At the same time that the caliper actuation signal is transmitted, CPU 18 transmits a deactivation signal to power train control module 22 to deenergize vehicle motor. Thus, in the event of an impact, vehicle 14 is automatically caused to stop moving in the shortest distance and time.

From the foregoing, it should be appreciated that the use of system 10 is straightforward. As vehicle 14 travels down a first roadway 38, camera 12 gathers light during daytime or nighttime operations reflected from a stop sign 16 marking an intersection with a second roadway 40. Camera 12 produces a video signal that is transmitted to CPU 18 and processed by algorithm so as to detect red light from stop sign 16. In the event that the speed of vehicle 14, as determined by algorithm measuring variations in the intensity of the red light from stop sign 16, exceeds a preset limit, CPU 18 causes audible alarm 36 to sound. If the driver of vehicle 14 does not respond to alarm 36 by depressing pedal 30, CPU 18 automatically signals power train control module 22 to reduce motor speed and signals brake calipers 20 to grip rotors 34 with suitable force to slow vehicle 14 to a stop in a comfortable fashion. If the driver of vehicle 14, however, does respond to alarm 36 by depressing pedal 30, CPU 18 refrains from slowing vehicle 14 to a stop. The automatic deceleration of vehicle 14 occurs similarly in the presence of red traffic lights, flashing school bus lights, and vehicle taillights.

Bumper sensors 28 detect the collision of vehicle 14 with an object. Upon receiving a contact signal from one of sensors 28, CPU 18 automatically causes power train control module 22 to idle the vehicle motor and cause calipers 20 to grip rotors 34 with maximum force. No warning of audible alarm 36 is sounded since immediate stopping of vehicle 14 is required and driver intervention is unnecessary to minimize harm.

In all cases, the amount of force that calipers 20 grip rotors 34 is derived, in part, from temperature signals transmitted to CPU 18 by brake sensors 26. CPU 18 causes calipers 20 to grip with greater force at times when cold temperatures are detected than when warm temperatures are detected. Thus, system 10 provides an added degree of safety, in the form of audible warnings and positive braking actions that take into account environmental conditions, for the occupants of vehicle 14 and others who may come into contact with vehicle 14 while it is being driven.

While braking system 10 has been described with a high degree of particularity, it will be appreciated by those skilled in the art that modifications can be made to it. For example, CPU 18 can be programmed to pulse the actuation signals to brake calipers 20 as an anti-lock feature to keep rotors 34 for becoming fixed within the grip of calipers 20. Therefore, it is to be understood that the present invention is not limited solely to system 10 described above, but encompasses any and all braking systems within the scope of the following claims.

I claim:

1. A braking system in a land vehicle having a plurality of wheels for movement and a motor for the rotation of the wheels, the braking system comprising:
a brake rotor being secured for rotational movement to one of the wheels of the land vehicle;
a brake caliper being secured to the land vehicle for grasping said brake rotor in response to a caliper actuation signal;
a brake pedal being secured to the land vehicle for movement by the vehicle driver;
a pedal sensor being connected to said brake pedal for sensing the movement thereof and generating a transmissible braking signal in response to the movement of said brake pedal;
a power train control module for controlling the speed at which the motor rotates the wheels in response to a deactivation signal;
a camera being mounting on the land vehicle for generating a transmissible video signal representative of the incident light entering camera; and,
a central processing unit being connected to said pedal sensor, said brake caliper and said camera, said central processing unit being adapted to receive said braking signal from said pedal sensor and, in response to receiving said braking signal, transmit a caliper actuation signal to said brake caliper and simultaneously transmit a deactivation signal to said power train control module; and said central processing further unit being adapted to receive said video signal from said camera and process said video signal to determine whether the incident light entering said camera includes light of a red color and, in response to detecting light of a red color, transmit a caliper actuation signal to said brake caliper and simultaneously transmit a deactivation signal to said power train control module.

2. The braking system according to claim 1 further comprising a brake sensor being connected to said brake caliper for producing a transmissible temperature signal being proportional to the temperature of said brake caliper, and said central processing unit being connected to said brake sensor and using said temperature signal in the formulation of said caliper actuation signal.

3. The braking system according claim 1 wherein said central processing unit is adapted to produce a transmissible alarm actuation signal at a set time prior to producing a caliper actuation signal and said braking system further comprises an alarm being connected to said central processing unit for generating an audible alarm upon receiving said alarm actuation signal from said central processing unit.

4. The braking system according to claim 1 further comprising a bumper sensor being secured to said vehicle for detecting an impact with a foreign object and for producing a contact signal in response to the impact and wherein said central processing unit is connected to said bumper sensor and transmits a caliper actuation signal to said brake caliper and also transmits a deactivation signal to said power train control module in response to receiving a contact signal from said bumper sensor.
